(19) United States
(12) Patent Application Publication
(10) Pub. No.: US 2018/0341775 A1
(43) Pub. Date: Nov. 29, 2018

(54) DIGITAL LICENSE AUTHENTICATION WITH SECURE PRIVACY LOGGING

(71) Applicant: International Business Machines Corporation, Armonk, NY (US)

(72) Inventors: Daniel A. Gisolfi, Hopewell, NY (US); Richard Redpath, Cary, NC (US)

(73) Assignee: International Business Machines Corporation, Armonk, NY (US)

(21) Appl. No.: 15/602,178

(22) Filed: May 23, 2017

(51) Int. Cl. G06F 21/60; H04L 9/32; H04L 9/30

(52) U.S. Cl. CPC G06F 21/602; H04L 9/30; H04L 9/3247

(57) ABSTRACT

Methods and systems may provide for technology to receive, by a computing device, privacy information, a unique identifier (ID) and one or more digital signatures associated with the privacy information and the unique ID. Additionally, the technology may store the unique ID and the digital signature(s) to a record of an authentication log on the computing device and delete the privacy information from the computing device. In one example, the technology conducts a public key authentication of the digital signature(s).

### BACKGROUND

Embodiments generally relate to digital privacy. More particularly, embodiments relate to digital license authentication with secure privacy logging.

Information privacy may be a concern in a wide variety of settings, particularly when the information is maintained in electronic and/or digital form. For example, digital driving licenses may contain sensitive information such as, for example a photograph, handwritten signature or home address, that is transmitted from the license owner's computing device and another computing device (e.g., law enforcement officer's computing device) for confirmation of the identity of the license owner. In such a case, the recipient of the sensitive information might compare the visual appearance of the license owner to the photograph, query the license owner about the license owner's address, and so forth. The presence of the sensitive information on the other computing device may present privacy concerns, particularly when a log of the interaction is made (e.g., for subsequent reporting and/or court proceedings).

### BRIEF SUMMARY

Embodiments may include a computing device comprising a display, a power supply to provide power to the computing device, a processor coupled to the display and a memory subsystem coupled to the processor, the memory subsystem including an authentication log and program instructions, which when executed by the processor, cause the system to receive privacy information, a unique identifier and a digital signature associated with the privacy information and the unique identifier, conduct a public key authentication of the digital signature, visually present the privacy information via the display, store the unique identifier, the digital signature and key information associated with the public key authentication to a record of the authentication log, delete the privacy information from the computing device and document the record as a blockchain transaction.

Embodiments may also include a computer program product to protect privacy, the computer program product comprising a computer readable storage medium having program instructions embodied therewith, the program instructions executable by a computing device to cause the computing device to receive privacy information, a unique identifier and a digital signature associated with the privacy information and the unique identifier, store the unique identifier and the digital signature to a record of an authentication log on the computing device and delete the privacy information from the computing device.

Embodiments may also include a method comprising receiving, by a computing device, privacy information, a unique identifier and a digital signature associated with the privacy information and the unique identifier, storing the unique identifier and the digital signature to a record of an authentication log on the computing device and deleting the privacy information from the computing device.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example a privacy-related scenario according to an embodiment;

FIG. 2 is a flowchart of an example of a method of conducting secure privacy logging according to an embodiment;

FIG. 3 is a flowchart of an example of a more detailed method of conducting secure privacy logging according to an embodiment; and

FIG. 4 is a block diagram of an example of a computing device according to an embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

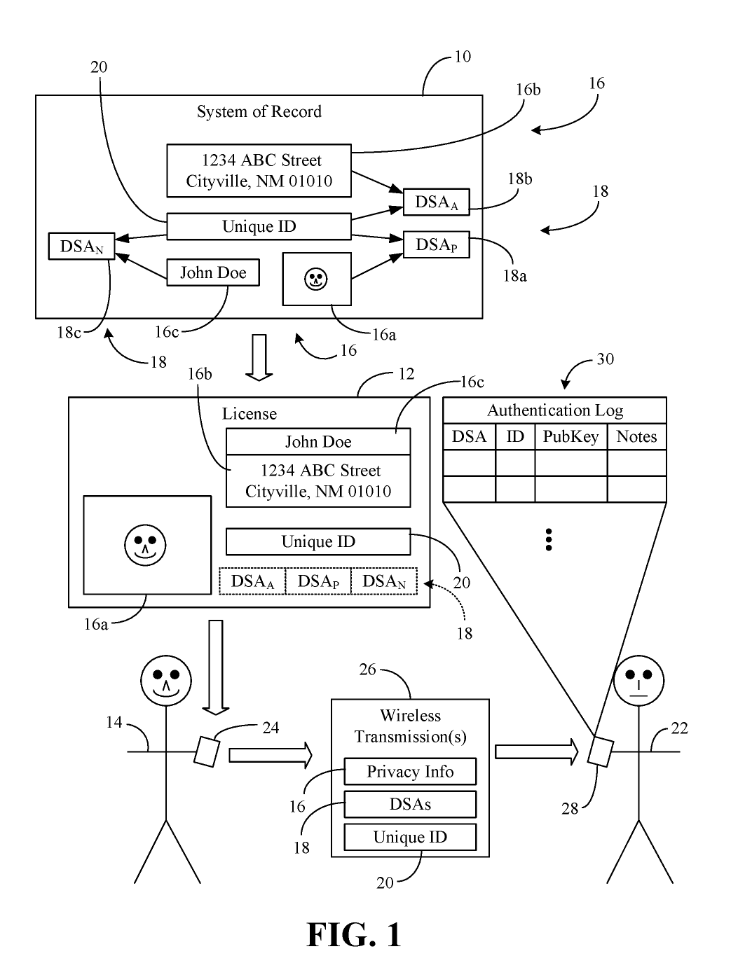

Turning now to FIG. 1, a privacy-related scenario is shown in which a system of record (SOR, e.g., Department of Motor Vehicles) 10 issues a digital license 12 or other electronic identification (ID, e.g., state ID, passport) to an individual 14 (e.g., user, citizen). In the illustrated example, the SOR 10 uses privacy information 16 (16a-16c) and a unique identifier 20 (e.g., device identifier, random number, driving license number, state ID number, passport number) associated with the individual 14 to generate a set of digital signatures 18 (18a-18c). The device identifier may be, for example, a universally unique identifier (UUID) associated with a first computing device 24 (e.g., smart phone, personal digital assistant/PDA, wearable device, tablet computer, notebook computer, convertible tablet, desktop computer) carried by the individual 14. The unique identifier 20 may also be a value generated by the SOR 10 solely to create digital signatures.

The digital signatures 18 may be generated in accordance with digital signature algorithm (DSA) technology, elliptic curve DSA (ECDSA) technology, RSA (Rivest, Shamir, Adleman, e.g., RSA 2048) technology, or other suitable authentication technology. The SOR 10 may maintain private keys (not shown) associated with the digital signatures 18 and make public keys (not shown) associated with the digital signatures 18 generally available to others such as, for example, a third party 22 (e.g., law enforcement official, notary, banker).

Thus, a photograph 16a of the individual 14 and the unique ID 20 may be used to generate a first digital signature 18a (e.g., photograph DSA/DSA_{P}). Similarly, an address 16b of the individual 14 and the unique ID 20 may be used to generate a second digital signature 18b (e.g., address DSA/DSA_{A}). Additionally, a name 16c of the individual 14 and the unique ID 20 may be used to generate a third digital signature 18c (e.g., name DSA/DSA_{N}). Other privacy information such as, for example, a handwritten signature (not shown) of the individual 14 may also be used to generate a digital signature. In the illustrated example, the photograph 16a, the address 16b, the name 16c, the unique ID 20 and the set of digital signatures 18 are incorporated into the digital license 12, which is electronically transmitted to the first computing device 24 associated with the individual 14. Thus, when presented on a display of the first computing device 24, the digital license 12 may have the appearance of a traditional paper license.

In one example, the digital license 12 has the design format and data content of an ISO-compliant (e.g., International Organization for Standardization/International Electrotechnical Commission, ISO/IEC 18013) REAL ID driving license with regard to human-readable features, machine-readable features, and access control, authentication and integrity validation. Thus, the photograph 16a may reside in an ISO07 portrait data field and the address 16b may reside in an ISO08 address data field. In one example, the unique ID 20 may reside in an ISO04 owner ID field. Alternatively, the unique ID 20 may be a value (e.g., UUID, random number) that does not reside in the ISO04 owner ID field. Such an approach may further enhance privacy. Other formats may also be used.

The individual 14 may encounter the third party 22 in a setting in which the third party 22 verifies the identity of the individual 14. For example, the third party 22 may be a law enforcement officer and the setting may be a traffic stop. In such a case, the third party 22 might ask the individual 14 to conduct one or more wireless transmissions 26 (e.g., Bluetooth, near field communications/NFC, WiFi, personal area network/PAN, cellular, infrared/IR, wireless regional area network/WRAN, radio frequency identifier/RFID, ultra wideband/UWB, wireless highway addressable remote transducer/HART, ZigBee) of the privacy information 16, the digital signatures 18 and the unique ID 20 from the first computing device 24 to a second computing device 28 associated with the third party 22. The wireless transmissions 26 may involve a handshake protocol such as, for example, a transport layer security (TLS) handshake protocol (e.g., using Advanced Encryption Standard/AES 1218). Alternatively, the privacy information 16, digital signatures 18 and/or unique ID 20 may be incorporated into a barcode or quick response (QR) code printed on a package, airline ticket or other substrate received from the SOR 10. In such a case, the second computing device 28 may include a scanner (e.g., camera and code recognition application) to capture the information.

The public keys corresponding to the digital signatures 18 may be pre-loaded on or pulled to (e.g., on demand) the second computing device 28 so that, upon receiving the wireless transmissions 26, the second computing device 28 may conduct a public key authentication of the digital signatures 18. Thus, failure of the public key authentication may indicate that, for example, the photograph 16a, the address 16b and/or the name 16c in the privacy information 16 have been tampered with. In such a case, the second computing device 28 may generate a warning message (e.g., “Invalid License”).

Additionally, the second computing device 28 may visually present the privacy information 16 on a display of the second computing device 28 for the third party 22 view. The third party 22 may therefore visually compare the physical appearance of the individual 14 with the photograph 16a, interrogate the individual 14 about the address 16b and/or the name 16c, and so forth. The third party 22 may also create a record of the interaction in an authentication log 30 for later transmission, download and/or documentation (e.g., in a blockchain). The illustrated authentication log 30 stores the digital signature, unique ID and key information associated with the public key authentication (e.g., if public key information is updated due to passage of time or population usage) for each record.

In the law enforcement case, the authentication log 30 may be a scratch log in which the third party 22 adds one or more notes (e.g., “scratch”) to each record/entry in the authentication log 30. As will be discussed in greater detail, the illustrated privacy information 16 is not included in the authentication log 30 in order to protect the privacy of the individual 14. Indeed, the second computing device 28 may be configured to automatically delete the privacy information 16 from the computing device 28 once the third party 22 has verified the identity of the individual 14. In this regard, the deletion of the privacy information may be triggered by user input from the third party 22 (e.g., selection of an “Identity verified” menu option), expiration of a timer (e.g., a predefined or variable interrogation/transaction period), and so forth. In yet another example, only the display of the second computing device 28 may be provided with the privacy information 16 during viewing (e.g., as in SNAPCHAT functionality).

The illustrated solution may also be used in other scenarios such as, for example, notary and/or financial transaction scenarios. More particularly, the third party 22 may be notary, wherein the privacy information 16 also includes a handwritten signature that the third party 22 compares to the real-time signature of the individual 14. In yet another example, the third party 22 may be a title representative who compares the real-time signature of the individual 14 to a handwritten signature in the privacy information 16 during a loan closing. Other scenarios may include, for example, bars, nightclubs, airline travel, and so forth.

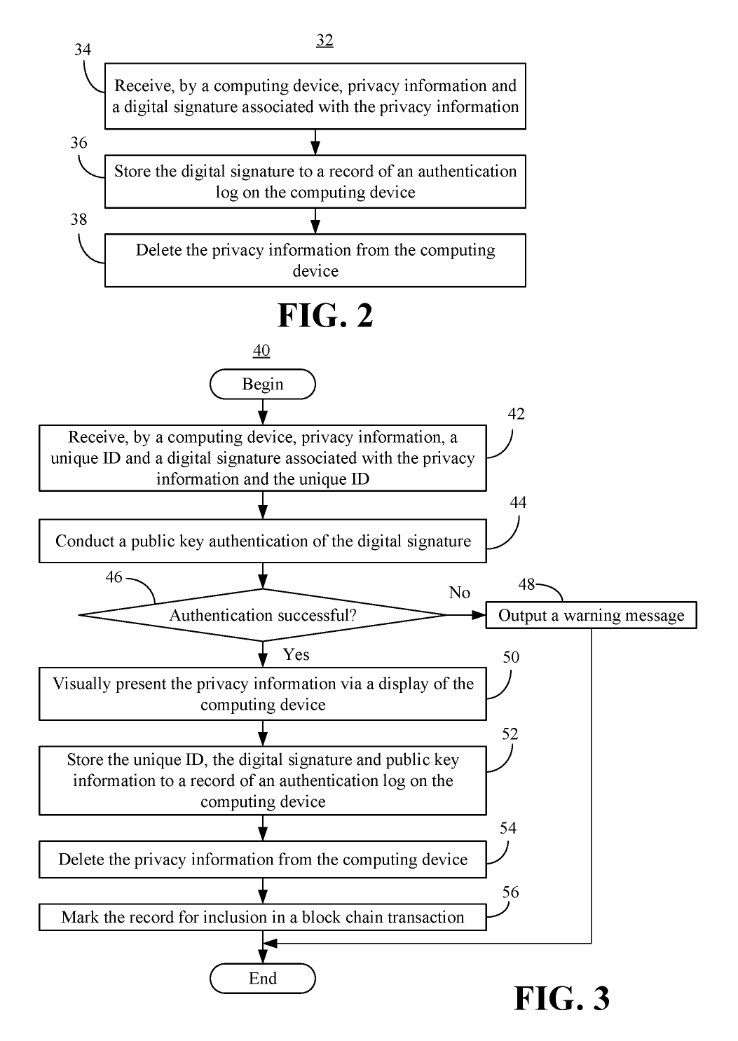

FIG. 2 shows a method 32 of conducting secure privacy logging. The method 32 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.). In one example, the method 32 is implemented in a computing device such as, for example, the second computing device 28 (FIG. 1), already discussed.

Illustrated processing block 34 provides for receiving, by a computing device, privacy information and a digital signature associated with the privacy information. The privacy information may include, for example, a photograph, a handwritten signature, an address, a name, etc., or any combination thereof. Additionally, block 34 may optionally receive the unique ID used to generate the digital signature. As already noted, the unique ID may include, for example, a device identifier, a random number (e.g., “true” random number, pseudorandom number having sufficient entropy), a driving license number, a state ID number, a passport number, etc., or any combination thereof If block 34 does not receive the unique ID, the unique ID may be retrieved subsequently (e.g., via the courts directly from the SOR, which typically maintains a historical record of previously used unique IDs).

The digital signature may be compliant with ECDSA, RSA, and so forth. The unique ID and the digital signature may be stored to a record of an authentication log on the computing device at block 36, wherein the authentication log may include, for example, a law enforcement scratch log, a notary log, a financial transaction log, etc., or any combination thereof. Illustrated block 38 deletes the privacy information from the computing device (e.g., in response to user input, timer expiration, etc.). By deleting the privacy information from the computing device, the method 32 may substantially enhance privacy while enabling the interaction to be documented for future use.

FIG. 3 shows a more detailed method 40 of conducting secure privacy logging. The method 40, which may be incorporated into a computing device such as, for example, the second computing device 28 (FIG. 1), already discussed, may generally be implemented in fixed-functionality hardware, configurable logic, logic instructions, etc., or any combination thereof. Illustrated processing block 42 receives, by a computing device, privacy information (e.g., photograph, handwritten signature, address, name), a unique ID (e.g., driving license number, state ID number, passport number) and a digital signature (e.g., ECDSA, and/or RSA signature) associated with the privacy information and the unique ID. A public key authentication of the digital signature may be conducted at block 44. If it is determined at block 46 that the authentication has been unsuccessful, block 48 may output a warning message (e.g., visible, audible, haptic, olfactory) and the illustrated method 40 terminates.

If it is determined at block 46 that the public key authentication has been successful, illustrated block 50 visually presents the privacy information via a display of the computing device in response to the successful authentication. Block 50 may therefore include displaying the photograph, address, name, handwritten signature and/or other sensitive data to the user of the computing device. Illustrated block 52 stores the unique ID, the digital signature and key information associated with the public key authentication to a record of an authentication log on the computing device. Block 52 may also include prompting the user of the computing device to enter scratch notes (e.g., behavioral observations) associated with the interaction to the authentication log. The privacy information may be deleted from the computing device at block 54. Block 54 may therefore include conducting one or more erase operations with respect to volatile and/or non-volatile memory.

The record may be marked (e.g., flagged) at block 56 for inclusion in a blockchain transaction. In this regard, the record may be added (e.g., by a remote site having access to the appropriate private keys) to a continuously growing list of ordered records called blocks, wherein each block contains a timestamp and a link to a previous block. The blockchain may be inherently resistant to modification of the data because once recorded, the data in a block cannot be altered retroactively. Accordingly, the authenticity of the record may be subsequently verified in, for example, court proceedings without including privacy information in the record. Indeed, the blockchain transaction may render the record “non-reputable” to the extent that it prevents the owner of the privacy information from denying that the information exchange took place. The blockchain transaction may be conducted on a remote system such as, for example, a law enforcement server.

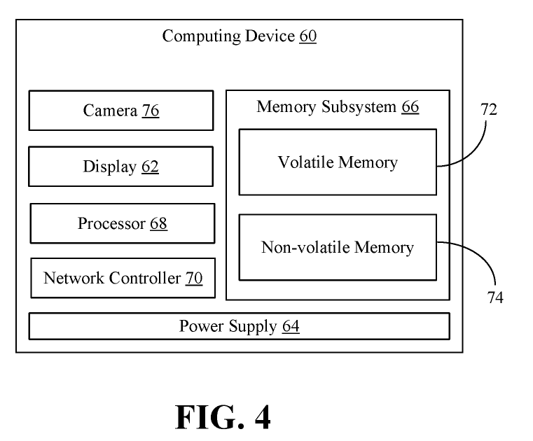

Turning now to FIG. 4, a privacy-enhanced computing device 60 is shown. The computing device 60, which may implement one or more aspects of the method 32 (FIG. 2) and/or the method 40 (FIG. 3), already discussed, may be readily substituted for the second computing device 28 (FIG. 1), already discussed. In the illustrated example, the computing device 60 includes a display 62, a power supply 64 to provide power to the computing device 60, a memory subsystem 66, a processor 68, a camera 76 and a network controller 70 (e.g., Bluetooth, NFC, WiFi, PAN, cellular, IR, WRAN, RFID, UWB, wireless HART, ZigBee). The memory subsystem 66, which may be coupled to the processor 68, may include an authentication log and program instructions stored in volatile memory 72 (e.g., dynamic random access memory/DRAM, static RAM/SRAM) and/or non-volatile memory 74 (NVM, e.g., read only memory/ROM, programmable ROM/PROM, flash memory, hard disk drive/HDD, optical disc, solid state drive/SSD, ferroelectric RAM).

In one example, when executed by the processor 68, the program instructions cause the computing device 60 to receive, via the camera 76 and/or the network controller 70 privacy information, a unique ID and one or more digital signatures associated with the privacy information and the unique identifier. Additionally, execution of the program instructions by the processor 68 may cause the computing device 60 to conduct a public key authentication of the digital signature(s), visually present the privacy information via the display 62, and store the unique ID, the digital signature(s) and public key information to a record of the authentication log. Execution of the program instructions may also cause the computing device 60 to delete the privacy information from the computing device 60 and document the record as a block chain transaction. If the privacy information, the digital signatures and/or the unique ID are incorporated into a barcode or QR code, execution of the program instructions may also cause the computing device 60 to recognize, interpret and/or read the barcode or QR code.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computing device comprising:
a display;
a power supply to provide power to the computing device;
a processor coupled to the display; and
a memory subsystem coupled to the processor, the memory subsystem including an authentication log and program instructions, which when executed by the processor, cause the computing device to:
receive privacy information, a unique identifier and a digital signature associated with the privacy information and the unique identifier;
conduct a public key authentication of the digital signature;
visually present the privacy information via the display;
store the unique identifier, the digital signature and key information associated with the public key authentication to a record of the authentication log;
delete the privacy information from the computing device; and
mark the record for inclusion in a blockchain transaction.

2. The computing device of claim 1, wherein the privacy information is selected from a group consisting of a photograph, a handwritten signature, an address and a name.

3. The computing device of claim 1, wherein the unique identifier is selected from a group consisting of a device identifier, a random number, a driving license number, a state identification number and a passport number.

4. The computing device of claim 1, wherein the authentication log is selected from a group consisting of a law enforcement scratch log, a notary log and a financial transaction log.

5. A computer program product to protect privacy, the computer program product comprising a computer readable storage medium having program instructions embodied therewith, the program instructions executable by a computing device to cause the computing device to:
receive privacy information and a digital signature associated with the privacy information;
store the digital signature to a record of an authentication log on the computing device; and
delete the privacy information from the computing device.

6. The computer program product of claim 5, wherein the program instructions, when executed, cause the computing device to conduct a public key authentication of the digital signature.

7. The computer program product of claim 6, wherein the program instructions, when executed, cause the computing device to store key information associated with the public key authentication to the record.

8. The computer program product of claim 5, wherein the program instructions, when executed, cause the computing device to visually present the privacy information via a display of the computing device.

9. The computer program product of claim 5, wherein the program instructions, when executed, cause the computing device to mark the record for inclusion in a blockchain transaction.

10. The computer program product of claim 5, wherein the privacy information is selected from a group consisting of a photograph, a handwritten signature, an address and a name.

11. The computer program product of claim 5, wherein the unique identifier is selected from a group consisting of a device identifier, a random number, a driving license number, a state identification number and a passport number, and wherein the authentication log is selected from a group consisting of a law enforcement scratch log, a notary log and a financial transaction log.

12. The computer program product of claim 5, wherein the program instructions, when executed, cause the computing device to:
receive a unique identifier associated with the privacy information and the digital signature; and
store the unique identifier to the record.

13. A method comprising:
receiving, by a computing device, privacy information and a digital signature associated with the privacy information;
storing the digital signature to a record of an authentication log on the computing device; and
deleting the privacy information from the computing device.

14. The method of claim 13, further including conducting a public key authentication of the digital signature.

15. The method of claim 14, further including storing key information associated with the public key authentication to the record.

16. The method of claim 13, further including visually presenting the privacy information via a display of the computing device.

17. The method of claim 13, further including marking the record for inclusion in a blockchain transaction.

18. The method of claim 13, wherein the privacy information is selected from a group consisting of a photograph, a handwritten signature, an address and a name.

19. The method of claim 13, wherein the unique identifier is selected from a group consisting of a device identifier, a random number, a driving license number, a state identification number and a passport number, and wherein the authentication log is selected from a group consisting of a law enforcement scratch log, a notary log and a financial transaction log.

20. The method of claim 13, further including:
receiving a unique identifier associated with the privacy information and the digital signature; and
storing the unique identifier to the record.
